(19) United States
(12) Patent Application Publication
(10) Pub. No.: US 2025/0150121 A1
(43) Pub. Date: May 8, 2025

(54) METHOD TO SIGNAL ASSISTANT INFORMATION FOR A USER EQUIPMENT SUPPORTING ADVANCED RECEIVER FOR MU-MIMO

(71) Applicant: Nokia Technologies Oy, Espoo (FI)

(72) Inventors: Andrew LAPPALAINEN, Union City, NJ (US); Karsten PETERSEN, Aalborg (DK)

(21) Appl. No.: 18/932,737

(22) Filed: Oct. 31, 2024

Related U.S. Application Data
(60) Provisional application No. 63/595,848, filed on Nov. 3, 2023.

(51) Int. Cl. H04B 7/0452

(52) U.S. Cl. CPC H04B 7/0452

(57) ABSTRACT

In accordance with embodiments, there are disclosed a method and apparatus for receiving, from a network, a configuration for multi-user multiple input multiple output; and apply at least one default setting for at least one parameter for a multi-user multiple input multiple output advanced receiver, based on the configuration for multi-user multiple input multiple output; receive, from the network, a configuration for the at least one parameter for the multi-user multiple input multiple output advanced receiver; and apply at least one non-default setting for one or more of the at least one parameter for the multi-user multiple input multiple output advanced receiver, in response to the one or more of the at least one parameter being present within the configuration for the at least one parameter for the multi-user multiple input multiple output advanced receiver.

### TECHNICAL FIELD

The examples and non-limiting example embodiments relate generally to communications and, more particularly, to a method to signal assistant information for a user equipment supporting an advanced receiver for MU-MIMO.

### BACKGROUND

It is known for a communication device to receive signaling in a communication network.

### SUMMARY

Various aspects of examples of the invention are set out in the claims.

According a first aspect of the present invention, disclosed are a method and apparatus for receiving, from a network, a configuration for multi-user multiple input multiple output; and applying at least one default setting for at least one parameter for a multi-user multiple input multiple output advanced receiver, based on the configuration for multi-user multiple input multiple output.

According a second aspect of the present invention, disclosed are a method and apparatus for determining a configuration for multi-user multiple input multiple output; and transmitting, to a user equipment, the configuration for multi-user multiple input multiple output; wherein the configuration for multi-user multiple input multiple output causes the user equipment to apply at least one default setting for at least one parameter for a multi-user multiple input multiple output advanced receiver.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows configuring a UE with the default and non-default network assistant signaling settings for an MU-MIMO advanced receiver.

FIG. 3 is an example apparatus configured to implement the examples described herein.

FIG. 4 shows a representation of an example of non-volatile memory media used to store instructions that implement the examples described herein.

FIG. 5 is an example method, based on the examples described herein.

FIG. 6 is an example method, based on the examples described herein.

### DETAILED DESCRIPTION OF EXAMPLE EMBODIMENTS

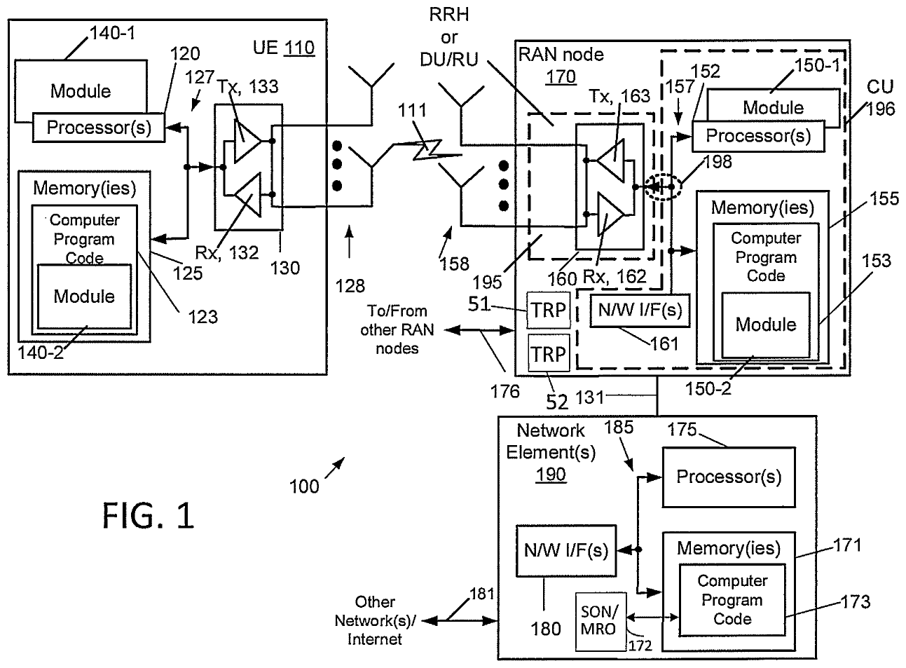

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization.

Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Under the 3GPP Rel-18 RAN work item (WI) for NR demodulation performance evolution [RP-232685], RAN Working Group 4 (RAN4) has been examining how to further enhance DL throughput and coverage performance by studying and specifying requirements for more advanced UE receivers for the MU-MIMO scenario.

One main objective of this WI is to introduce network assistant signaling to support advanced UE receivers to cancel inter-user interference in the MU-MIMO context, e.g. according to R4-2309895 and R4-2316980, with the following related sub-objectives: identify the required signaling for supporting advanced receiver to cancel inter-user interference for MU-MIMO, introduce DCI based assistant signaling, and introduce RRC based assistant signaling and UE capability.

Further details of the high-level requirements being considered for the RRC-based network assistant signaling are discussed in RAN4's liaison statement to RAN Working Group 2 (RAN2), which are detailed below [R4-2316980].

RAN4 discussed the need for UE network assistance signaling for MU-MIMO advanced receiver(s) for the UEs capable of utilizing advanced receiver supporting cancellation of 1 or more co-scheduled UEs. As an outcome, RAN4 agreed it is beneficial to introduce new Rel-18 RRC based network assistance signaling to assist UEs supporting MU-MIMO advanced receiver(s) by providing additional information related to co-scheduled UE(s). Regarding the content of the Rel-18 new RRC network assistance signaling, RAN4 agreed on the need for the following (1-2):
1. Dedicated RRC signaling is provided to the UE (target UE) to indicate the information in each of the following bullets separately, when the information is available (1a-1d):
1a. For the target and any co-scheduled UEs in different CDM groups and with the same DMRS sequence, whether the target UE can assume the precoding and resource allocation of the co-scheduled UE are the same in the PRG-level grid configured to the target UE when PRG=2 or 4.
1b. Whether the DM-RS power boosting configurations (i.e., Number of DM-RS CDM groups without data, TS38.214 table 4.1-1) of all the co-scheduled UE(s), which has the same DM-RS sequence as the target UE, is the same as the target UE.
1c. Whether the time domain resource assignment for PDSCH symbols of all the co-scheduled UE(s), which has the same DM-RS sequence as the target UE, is same as the target UE.
1d. The MCS table with the highest modulation order among all MCS tables configured to the co-scheduled UE(s), which has the same DM-RS sequence as the target UE. The MCS table is one of the following: 1024 QAM MCS table(s) (Table 5.1.3.1-4 from TS38.214), 256 QAM MCS table(s) (Table 5.1.3.1-2 from TS38.214), or 64 QAM MCS tables (Table 5.1.3.1-1 or 5.1.3.1-3 from TS38.214).
2. In addition, RAN4 agreed that the existence of the MU-MIMO DCI signaling, as included in the liaison statement to RAN Working Group 1 (RAN1) in R4-2309895, is configured by RRC signaling.

In R4-2315907, some additional aspects of the RRC-based network assistant signaling were discussed; for example, it was suggested that, by default, a UE supporting advanced receiver for MU-MIMO should assume each of the first three bullets described under 1) should be assumed as valid/true, and that the network can optionally signal in an RRC-message from the network to the UE whether any one or more of those assumptions is false.

In Rel-17, a similar concept of applying default assumptions to network assistant signaling and explicitly indicating when those assumptions were not valid was specified for CRS interference mitigation in scenarios with overlapping LTE-NR spectrum [TS 38.331 section 6.3.2]. For that scenario, the UE assumes a set of default configurations are valid unless the network explicitly indicates the field lte-NeighCellsCRS-Assumptions as false via RRC signaling, and indicates at the same time a list of LTE neighbor cells configuration information under the lte-NeighCellsCRS-AssistInfoList, which is used to assist the UE to perform CRS interference mitigation.

Within RAN4 discussions, a number of companies had preferred for the network to explicitly signal to the target UE whether each of the following advanced receiver assumptions is valid (true) or not valid (false) (a-c):
a) The precoding and resource allocation of the co-scheduled UE(s), which have the same DM-RS sequence as the target UE and are in different CDM groups from the target UE, are the same in the PRG-level grid configured to the target UE when PRG=2 or 4.
b) The DM-RS power boosting configurations of all the co-scheduled UE(s), which have the same DM-RS sequence as the target UE, is the same as the target UE.
c) The time domain resource assignment for PDSCH symbols of all the co-scheduled UE(s), which have the same DM-RS sequence as the target UE, is same as the target UE.

However, under such a framework there would be ambiguity when the network does not send any assistant signaling for MU-MIMO advanced receiver to the UE. Therefore, this motivates the need to define some default configuration for MU-MIMO advanced receiver.

Assuming some default configuration can be known, another issue is how to inform the UE when the default configuration no longer applies and how to return to such default configuration assumptions. One way to handle this could be with explicit signaling whether the default assumptions are valid (in the same vein of network assistant signaling for CRS interference mitigation for overlapping LTE-NR spectrum), but this may not be the only approach.

Described herein is a method for a network to signal to a UE supporting MU-MIMO advanced receiver(s) whether to apply default or non-default assumptions related to the target UE's co-scheduled UE(s) in order to support inter-user interference cancellation at the advanced UE receiver. In this case a “default” assumption (either true or false) is based on the validity of the following statements related to the target UE's co-scheduled UE(s). Each statement is associated with a parameter configured by an RRC information element for MU-MIMO advanced receiver network assistant signaling ((a)-(c)):
(a) The precoding and resource allocation of the co-scheduled UE(s), which have the same DM-RS sequence as the target UE and are in different CDM groups from the target UE, are the same in the PRG-level grid configured to the target UE when PRG=2 or 4.
(b) The DM-RS power boosting configurations of all the co-scheduled UE(s), which have the same DM-RS sequence as the target UE, is the same as the target UE.
(c) The time domain resource assignment for PDSCH symbols of all the co-scheduled UE(s), which have the same DM-RS sequence as the target UE, is same as the target UE.

Since the MU-MIMO advanced receiver functionality is dependent on a UE being configured to receive MU-MIMO DCI signaling a priori, there is no need to explicitly signal the default configuration for the MU-MIMO advanced receiver network assistant signaling settings: upon being informed of the existence of the MU-MIMO DCI configuration via RRC signaling, the target UE applies the advanced receiver settings based on the default validities for the parameters associated with statements a), b), c). The MU-MIMO advanced receiver network assistant signaling parameters with default settings/validities need not be limited to the parameters associated with a), b), and c), however: additional parameters, which have default settings/validities known by the UE once the MU-MIMO DCI configuration is provided to the UE, could also be specified.

After providing the UE with the MU-MIMO DCI configuration, the network may optionally signal to the target UE in an RRC information element for MU-MIMO advanced receiver network assistant configuration whether the UE shall apply the non-default settings/validities for any one or more of the parameters.

The network could also provide additional parameters within the same RRC information element, which may or may not have default settings/validities as well. For example, the network could inform the UE of the MCS table with the highest modulation order among all MCS tables configured to the co-scheduled UE(s), which has the same DM-RS sequence as the target UE. In this case, the network explicitly signals: The MCS table with the highest modulation order among all MCS tables configured to the co-scheduled UE(s), which has the same DM-RS sequence as the target UE. The MCS table is one of the following: a 1024 QAM MCS table, a256 QAM MCS table, or a 64 QAM MCS table. If the network does not signal this parameter, then the default assumption made by the UE is that any of the above three MCS tables (1024 QAM, 256 QAM, 64 QAM) could be applicable.

The parameter associated with the MCS table with the highest modulation order can be signaled within the same MU-MIMO advanced receiver configuration as parameters (a), (b), (c). In this sense, this could be considered a parameter (d). Instead of being associated with a valid/invalid state/assumption, the default assumption of parameter (d) is: “the UE assumes any of the three MCS tables (1024 QAM, 256 QAM, 64 QAM) could have highest modulation order among all MCS tables configured to the co-scheduled UE(s)”. The non-default case for parameter (d) is where the network explicitly indicates which MCS table is the highest modulation order among all MCS tables configured to the co-scheduled UE(s).

Once a UE is configured with the non-default setting/validity for any one or more advanced receiver parameters, the network resets the configuration for the parameter(s) to the default setting/validity by signaling the RRC information element for MU-MIMO advanced receiver network assistant signaling configuration to the target UE and omitting the respective parameter from the RRC configuration. By omitting the parameter from the RRC information element, the network implicitly informs the UE that the configuration for the parameter shall be reset to the default setting.

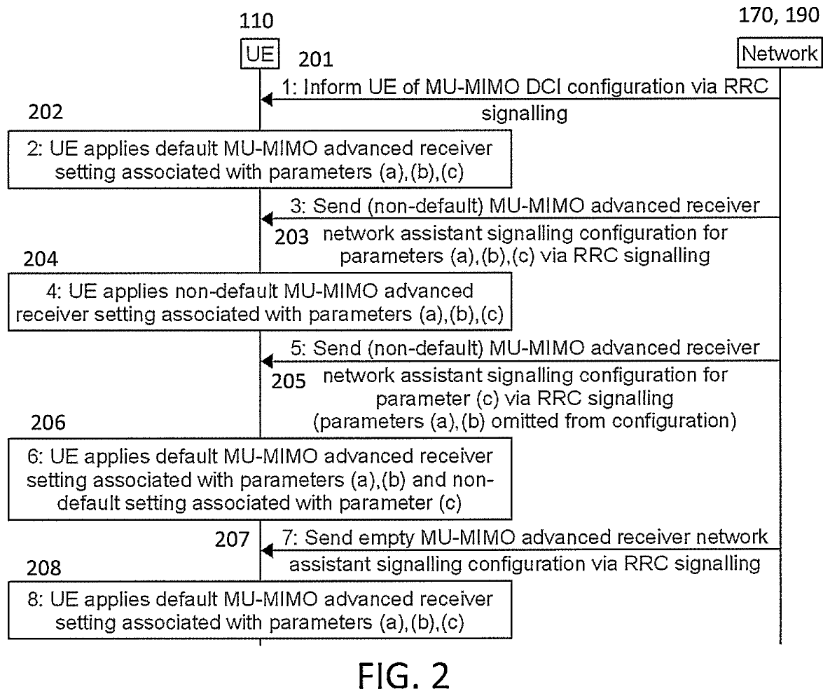

FIG. 2 shows the steps involved to configure the UE 110 with the default/non-default network assistant signaling settings for an MU-MIMO advanced receiver based on RRC signaling. In particular, FIG. 2 shows the signaling exchange between UE 110 and the network, where the network may include RAN node 170 and/or one or more network elements 190

In Step 1 (201), the UE is informed by the network of the configuration for MU-MIMO DCI. Based on the MU-MIMO DCI configuration, the UE may apply MU-MIMO advanced receiver settings based on network assistant signaling, and, in Step 2 (202), applies the default settings for the parameters (a), (b), (c) associated with the network assistant signaling.

The idea in Step 1 (201) and Step 2 (202) is that: Upon being informed of the MU-MIMO DCI configuration the UE 110 shall apply default MU-MIMO advanced receiver settings (no RRC-based network assistant signaling is needed to configure the advanced receiver in that case). Only in subsequent steps is explicit RRC-based network assistant signaling required.

In Step 3 (203), the network explicitly signals the non-default configuration to be used for the parameters (a), (b), (c) through the network assistant signaling for MU-MIMO advanced receiver. In Step 4 (204) the UE applies these (non-default) settings for parameters (a), (b), (c).

In Step 5 (205), the network explicitly signals the non-default configuration to be used for parameter (c) through the network assistant signaling for MU-MIMO advanced receiver; however, the network omits the configuration for parameters (a), (b), implicitly informing the UE to apply the default settings associated with parameters (a), (b). In Step 6 (206), the UE applies the default settings associated with parameters (a), (b), and the non-default setting that was explicitly signaled for parameter (c).

In Step 7 (207), the network sends an empty RRC information element for the MU-MIMO advanced receiver network assistant signaling, which implicitly informs the UE to apply the default settings associated with all parameters ((a), (b), (c)). In Step 8 (208), the UE applies the default settings associated with all of the parameters ((a), (b), (c)).

The examples described herein may be standardized in 3GPP, such as 3GPP TS 38.331, and possibly 38.306 or 38.213; 3GPP Release-18 compliant UEs capable of utilizing MU-MIMO advanced receiver(s) and supporting cancellation of one or more co-scheduled UEs and gNBs supporting the network assistant signaling for MU-MIMO advanced receiver configuration may implement the examples described herein. However, the examples described herein need not be limited to Rel-18, and the examples described herein may also be part of later 5G or 6G releases related to MU-MIMO advanced receivers.

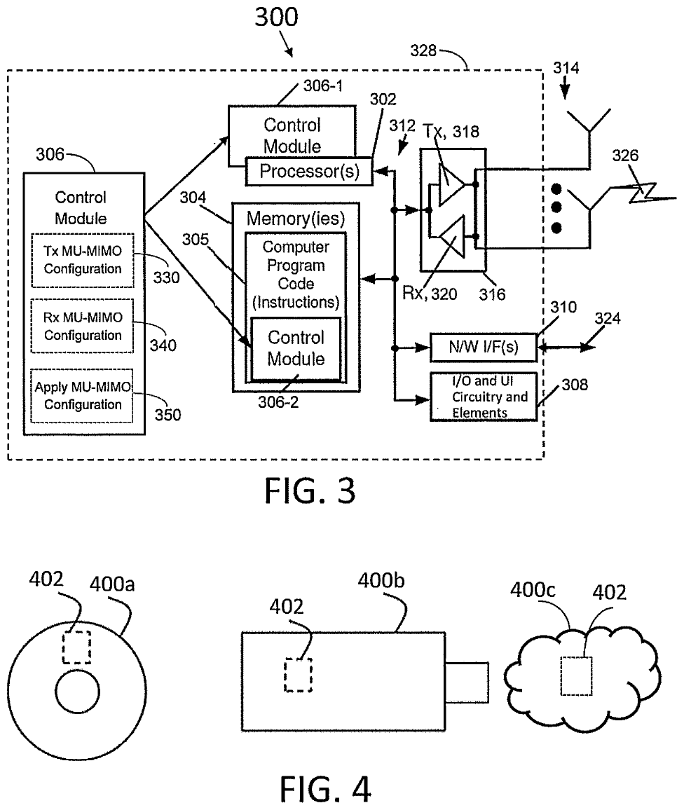

FIG. 3 is an example apparatus 300, which may be implemented in hardware, configured to implement the examples described herein. The apparatus 300 comprises at least one processor 302 (e.g. an FPGA and/or CPU), one or more memories 304 including computer program code 305, the computer program code 305 having instructions to carry out the methods described herein, wherein the at least one memory 304 and the computer program code 305 are configured to, with the at least one processor 302, cause the apparatus 300 to implement circuitry, a process, component, module, or function (implemented with control module 306) to implement the examples described herein. The memory 304 may be a non-transitory memory, a transitory memory, a volatile memory (e.g. RAM), or a non-volatile memory (e.g. ROM).

Optionally included Tx MU-MIMO receiver configuration 330 may implement the aspects described herein related to transmission of MU-MIMO configuration signaling and transmission of MU-MIMO advanced receiver network assistant signaling. Optionally included Rx MU-MIMO receiver configuration 340 may implement the aspects described herein related to reception of MU-MIMO configuration signaling and reception of MU-MIMO advanced receiver network assistant signaling. Optionally included apply MU-MIMO receiver configuration 350 may implement the aspects described herein related to application of MU-MIMO configuration signaling and application of MU-MIMO advanced receiver network assistant signaling.

The apparatus 300 includes a display and/or I/O interface 308, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 300 includes one or more communication e.g. network (N/W) interfaces (I/F(s)) 310. The communication I/F(s) 310 may be wired and/or wireless and communicate over the Internet/other network(s) via any communication technique including via one or more links 324. The link(s) 324 may be the link(s) 131 and/or 176 from FIG. 1. The link(s) 131 and/or 176 from FIG. 1 may also be implemented using transceiver(s) 316 and corresponding wireless link(s) 326. The communication I/F(s) 310 may comprise one or more transmitters or one or more receivers.

The transceiver 316 comprises one or more transmitters 318 and one or more receivers 320. The transceiver 316 and/or communication I/F(s) 310 may comprise standard well-known components such as an amplifier, filter, frequency-converter, (de)modulator, and encoder/decoder circuitries and one or more antennas, such as antennas 314 used for communication over wireless link 326.

The control module 306 of the apparatus 300 comprises one of or both parts 306-1 and/or 306-2, which may be implemented in a number of ways. The control module 306 may be implemented in hardware as control module 306-1, such as being implemented as part of the one or more processors 302. The control module 306-1 may be implemented also as an integrated circuit or through other hardware such as a programmable gate array. In another example, the control module 306 may be implemented as control module 306-2, which is implemented as computer program code (having corresponding instructions) 305 and is executed by the one or more processors 302. For instance, the one or more memories 304 store instructions that, when executed by the one or more processors 302, cause the apparatus 300 to perform one or more of the operations as described herein. Furthermore, the one or more processors 302, the one or more memories 304, and example algorithms (e.g., as flowcharts and/or signaling diagrams), encoded as instructions, programs, or code, are means for causing performance of the operations described herein.

The apparatus 300 to implement the functionality of control 306 may be UE 110, RAN node 170 (e.g. gNB), or one or more network elements 190 (e.g. LMF 190). Thus, processor 302 may correspond to processor(s) 120, processor(s) 152 and/or processor(s) 175, memory 304 may correspond to one or more memories 125, one or more memories 155 and/or one or more memories 171, computer program code 305 may correspond to computer program code 123, computer program code 153, and/or computer program code 173, control module 306 may correspond to module 140-1, module 140-2, module 150-1, and/or module 150-2, and communication I/F(s) 310 and/or transceiver 316 may correspond to transceiver 130, antenna(s) 128, transceiver 160, antenna(s) 158, N/W I/F(s) 161, and/or N/W I/F(s) 180. Alternatively, apparatus 300 and its elements may not correspond to either of UE 110, RAN node 170, or network element(s) 190 and their respective elements, as apparatus 300 may be part of a self-organizing/optimizing network (SON) node or other node, such as a node in a cloud.

The apparatus 300 may also be distributed throughout the network (e.g. 100) including within and between apparatus 300 and any network element (such as a network control element (NCE) 190 and/or the RAN node 170 and/or UE 110).

Interface 312 enables data communication and signaling between the various items of apparatus 300, as shown in FIG. 3. For example, the interface 312 may be one or more buses such as address, data, or control buses, and may include any interconnection mechanism, such as a series of lines on a motherboard or integrated circuit, fiber optics or other optical communication equipment, and the like. Computer program code (e.g. instructions) 305, including control 306 may comprise object-oriented software configured to pass data or messages between objects within computer program code 305. Computer program code (e.g. instructions) 305, including control 306 may comprise procedural, functional, or scripting code. The apparatus 300 need not comprise each of the features mentioned, or may comprise other features as well. The various components of apparatus 300 may at least partially be located in a common housing 328 (for example the components may be located within housing 328), or a subset of the various components of apparatus 300 may at least partially be located in different housings, which different housings may include housing 328.

FIG. 4 shows a schematic representation of non-volatile memory media 400a (e.g. computer/compact disc (CD) or digital versatile disc (DVD)) and 400b (e.g. universal serial bus (USB) memory stick) and 400c (e.g. cloud storage for downloading instructions and/or parameters 402 or receiving emailed instructions and/or parameters 402) storing instructions and/or parameters 402 which when executed by a processor allows the processor to perform one or more of the steps of the methods described herein. Instructions and/or parameters 402 may represent a non-transitory computer readable medium.

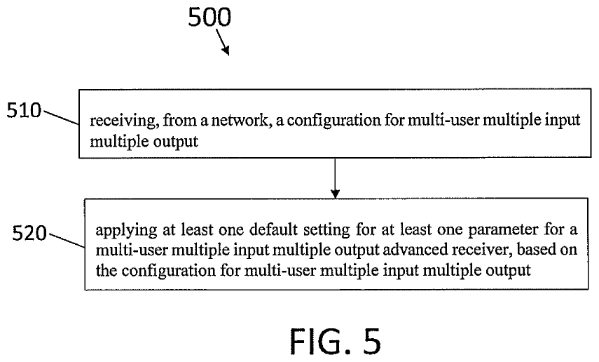

FIG. 5 is an example method 500, based on the example embodiments described herein. At 510, the method includes receiving, from a network, a configuration for multi-user multiple input multiple output. At 520, the method includes applying at least one default setting for at least one parameter for a multi-user multiple input multiple output advanced receiver, based on the configuration for multi-user multiple input multiple output. Method 500 may be performed with UE 110 or apparatus 300.

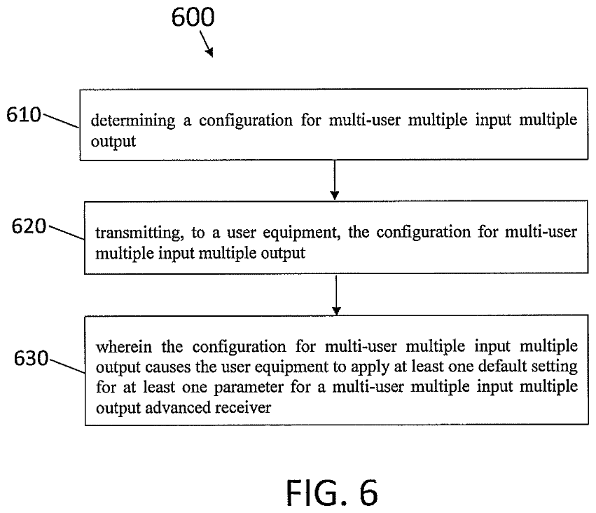

FIG. 6 is an example method 600, based on the example embodiments described herein. At 610, the method includes determining a configuration for multi-user multiple input multiple output. At 620, the method includes transmitting, to a user equipment, the configuration for multi-user multiple input multiple output. At 630, the method includes wherein the configuration for multi-user multiple input multiple output causes the user equipment to apply at least one default setting for at least one parameter for a multi-user multiple input multiple output advanced receiver. Method 600 may be performed with RAN node 170, one or more network elements 190, or apparatus 300.

The following examples are provided and described herein.

Example 1. An apparatus including: at least one processor; and at least one memory storing instructions that, when executed by the at least one processor, cause the apparatus at least to: receive, from a network, a configuration for multi-user multiple input multiple output; and apply at least one default setting for at least one parameter for a multi-user multiple input multiple output advanced receiver, based on the configuration for multi-user multiple input multiple output.

Example 2. The apparatus of example 1, wherein the instructions, when executed by the at least one processor, cause the apparatus at least to: receive, from the network, a configuration for the at least one parameter for the multi-user multiple input multiple output advanced receiver.

Example 3. The apparatus of example 2, wherein the instructions, when executed by the at least one processor, cause the apparatus at least to: receive, from the network, an empty information element associated with the configuration for the at least one parameter for the multi-user multiple input multiple output advanced receiver; apply the at least one default setting for the at least one parameter for the multi-user multiple input multiple output advanced receiver, in response to receiving the empty information element associated with the configuration for the at least one parameter for the multi-user multiple input multiple output advanced receiver.

Example 4. The apparatus of any of examples 2 to 3, wherein the instructions, when executed by the at least one processor, cause the apparatus at least to: determine to apply at least one non-default setting for one or more of the at least one parameter for the multi-user multiple input multiple output advanced receiver, in response to the one or more of the at least one parameter being present within the configuration for the at least one parameter for the multi-user multiple input multiple output advanced receiver.

Example 5. The apparatus of any of examples 2 to 4, wherein the instructions, when executed by the at least one processor, cause the apparatus at least to: determine to apply the at least one default setting for one or more of the at least one parameter for the multi-user multiple input multiple output advanced receiver, in response to the one or more of the at least one parameter being omitted from the configuration for the at least one parameter for the multi-user multiple input multiple output advanced receiver.

Example 6. The apparatus of any of examples 2 to 5, wherein the configuration for the at least one parameter for the multi-user multiple input multiple output advanced receiver is received from the network via radio resource control signaling.

Example 7. The apparatus of any of examples 2 to 6, wherein the instructions, when executed by the at least one processor, cause the apparatus at least to: receive, from the network, signaling of the configuration for the at least one parameter for the multi-user multiple input multiple output advanced receiver; wherein the signaling of the configuration for the at least one parameter for the multi-user multiple input multiple output advanced receiver comprises a modulation and coding scheme table having a highest modulation order higher among at least one modulation order of a respective at least one modulation and coding scheme table configured to a respective at least one co-scheduled user equipment, wherein a demodulation reference signal sequence of the at least one co-scheduled user equipment is the same as a demodulation reference signal sequence of the apparatus; wherein the at least one modulation and coding scheme table comprises one of: a 1024 quadrature amplitude modulation modulation and coding scheme table, or a 256 quadrature amplitude modulation modulation and coding scheme table, or a 64 quadrature amplitude modulation modulation and coding scheme table; and apply a non-default setting for the at least one parameter for the multi-user multiple input multiple output advanced receiver, wherein the non-default setting is based on the modulation and coding scheme table having the highest modulation order higher among the at least one modulation order of the respective at least one modulation and coding scheme table configured to the respective at least one co-scheduled user equipment.

Example 8. The apparatus of any of examples 2 to 7, wherein the instructions, when executed by the at least one processor, cause the apparatus at least to: apply, for the at least one parameter, a default assumption that any of three modulation and coding scheme tables have a highest modulation order among at least one modulation order of a respective at least one modulation and coding scheme table configured to a respective at least one co-scheduled user equipment, in response to determining that signaling of the configuration for the at least one parameter for the multi-user multiple input multiple output advanced receiver is received without a modulation and coding scheme table having the highest modulation order among the at least one modulation order of the respective at least one modulation and coding scheme table configured to the respective at least one co-scheduled user equipment; wherein the three modulation and coding scheme tables comprise a 1024 quadrature amplitude modulation modulation and coding scheme table, a 256 quadrature amplitude modulation modulation and coding scheme table, and a 64 quadrature amplitude modulation modulation and coding scheme table.

Example 9. The apparatus of any of examples 2 to 8, wherein the configuration for the at least one parameter for the multi-user multiple input multiple output advanced receiver is received from the network via explicit radio resource control based network assistant signaling.

Example 10. The apparatus of any of examples 1 to 9, wherein the at least one parameter is associated with a valid state or a valid assumption.

Example 11. The apparatus of any of examples 1 to 10, wherein the at least one parameter is associated with an invalid state or an invalid assumption.

Example 12. The apparatus of any of examples 1 to 11, wherein the at least one parameter is associated with: a precoding and resource allocation of at least one co-scheduled user equipment being the same as a precoding and resource allocation of the apparatus, in a precoding resource block group level grid configured to the apparatus when there are two or four consecutive resource blocks associated with a precoding resource block group, wherein a demodulation reference signal sequence of the at least one co-scheduled user equipment is the same as a demodulation reference signal sequence of the apparatus, and wherein the at least one co-scheduled user equipment is in a first code division multiplexing group, and the apparatus is in a second code division multiplexing group different from the first code division multiplexing group.

Example 13. The apparatus of any of examples 1 to 12, wherein the at least one parameter is associated with: at least one demodulation reference signal power boosting configuration of a respective at least one co-scheduled user equipment being the same as a demodulation reference signal power boosting configuration of the apparatus, wherein a demodulation reference signal sequence of the at least one co-scheduled user equipment is the same as a demodulation reference signal sequence of the apparatus.

Example 14. The apparatus of any of examples 1 to 13, wherein the at least one parameter is associated with: at least one time domain resource assignment for physical downlink shared channel symbols of a respective at least one co-scheduled user equipment being the same as a time domain resource assignment for physical downlink shared channel symbols of the apparatus, wherein a demodulation reference signal sequence of the at least one co-scheduled user equipment is the same as a demodulation reference signal sequence of the apparatus.

Example 15. The apparatus of any of examples 1 to 14, wherein the at least one default setting for the at least one parameter for the multi-user multiple input multiple output advanced receiver is known to the apparatus following receipt of the configuration for multi-user multiple input multiple output.

Example 16. The apparatus of any of examples 1 to 15, wherein the at least one default setting for the at least one parameter for the multi-user multiple input multiple output advanced receiver is applied in response to receipt of the configuration for multi-user multiple input multiple output, without receipt or use of radio resource control based network assistant signaling for configuration of the multi-user multiple input multiple output advanced receiver.

Example 17. The apparatus of any of examples 1 to 16, wherein the apparatus comprises a user equipment.

Example 18. An apparatus including: at least one processor; and at least one memory storing instructions that, when executed by the at least one processor, cause the apparatus at least to: determine a configuration for multi-user multiple input multiple output; and transmit, to a user equipment, the configuration for multi-user multiple input multiple output; wherein the configuration for multi-user multiple input multiple output causes the user equipment to apply at least one default setting for at least one parameter for a multi-user multiple input multiple output advanced receiver.

Example 19. The apparatus of example 18, wherein the instructions, when executed by the at least one processor, cause the apparatus at least to: transmit, to the user equipment, a configuration for the at least one parameter for the multi-user multiple input multiple output advanced receiver.

Example 20. The apparatus of example 19, wherein the instructions, when executed by the at least one processor, cause the apparatus at least to: transmit, to the user equipment, an empty information element associated with the configuration for the at least one parameter for the multi-user multiple input multiple output advanced receiver; and wherein the empty information element associated with the configuration for the at least one parameter for the multi-user multiple input multiple output advanced receiver is configured to cause the user equipment to apply the at least one default setting for the at least one parameter for the multi-user multiple input multiple output advanced receiver.

Example 21. The apparatus of any of examples 19 to 20, wherein the configuration for the at least one parameter for the multi-user multiple input multiple output advanced receiver causes the user equipment to apply at least one non-default setting for one or more of the at least one parameter for the multi-user multiple input multiple output advanced receiver, when the one or more of the at least one parameter is present within the configuration for the at least one parameter for the multi-user multiple input multiple output advanced receiver.

Example 22. The apparatus of any of examples 19 to 21, wherein the configuration for the at least one parameter for the multi-user multiple input multiple output advanced receiver causes the user equipment to apply the at least one default setting for one or more of the at least one parameter for the multi-user multiple input multiple output advanced receiver, when the one or more of the at least one parameter is omitted from the configuration for the at least one parameter for the multi-user multiple input multiple output advanced receiver.

Example 23. The apparatus of any of examples 19 to 22, wherein the configuration for the at least one parameter for the multi-user multiple input multiple output advanced receiver is transmitted to the user equipment via radio resource control signaling.

Example 24. The apparatus of any of examples 19 to 23, wherein the instructions, when executed by the at least one processor, cause the apparatus at least to: transmit, to the user equipment, signaling of the configuration for the at least one parameter for the multi-user multiple input multiple output advanced receiver; wherein the signaling of the configuration for the at least one parameter for the multi-user multiple input multiple output advanced receiver comprises a modulation and coding scheme table having a highest modulation order higher among at least one modulation order of a respective at least one modulation and coding scheme table configured to a respective at least one co-scheduled user equipment, wherein a demodulation reference signal sequence of the at least one co-scheduled user equipment is the same as a demodulation reference signal sequence of the user equipment; wherein the at least one modulation and coding scheme table comprises one of: a 1024 quadrature amplitude modulation modulation and coding scheme table, or a 256 quadrature amplitude modulation modulation and coding scheme table, or a 64 quadrature amplitude modulation modulation and coding scheme table; wherein the signaling of the configuration for the at least one parameter for the multi-user multiple input multiple output advanced receiver causes the user equipment to apply a non-default setting for the at least one parameter for the multi-user multiple input multiple output advanced receiver, wherein the non-default setting is based on the modulation and coding scheme table having the highest modulation order higher among the at least one modulation order of the respective at least one modulation and coding scheme table configured to the respective at least one co-scheduled user equipment.

Example 25. The apparatus of any of examples 19 to 24, wherein the instructions, when executed by the at least one processor, cause the apparatus at least to: transmit, to the user equipment, signaling of the configuration for the at least one parameter for the multi-user multiple input multiple output advanced receiver without a modulation and coding scheme table having a highest modulation order among at least one modulation order of a respective at least one modulation and coding scheme table configured to a respective at least one co-scheduled user equipment; wherein the signaling of the configuration for the at least one parameter for the multi-user multiple input multiple output advanced receiver without the modulation and coding scheme table having the highest modulation order among the at least one modulation order of the respective at least one modulation and coding scheme table configured to the respective at least one co-scheduled user equipment, causes the user equipment to apply a default assumption that any of three modulation and coding scheme tables have the highest modulation order among the at least one modulation order of the respective at least one modulation and coding scheme table configured to the respective at least one co-scheduled user equipment; wherein the three modulation and coding scheme tables comprise a 1024 quadrature amplitude modulation modulation and coding scheme table, a 256 quadrature amplitude modulation modulation and coding scheme table, and a 64 quadrature amplitude modulation modulation and coding scheme table.

Example 26. The apparatus of any of examples 19 to 25, wherein the configuration for the at least one parameter for the multi-user multiple input multiple output advanced receiver is transmitted to the user equipment via explicit radio resource control based network assistant signaling.

Example 27. The apparatus of any of examples 18 to 26, wherein the at least one parameter is associated with a valid state or a valid assumption.

Example 28. The apparatus of any of examples 18 to 27, wherein the at least one parameter is associated with an invalid state or an invalid assumption.

Example 29. The apparatus of any of examples 18 to 28, wherein the at least one parameter is associated with: a precoding and resource allocation of at least one co-scheduled user equipment being the same as a precoding and resource allocation of the user equipment, in a precoding resource block group level grid configured to the user equipment when there are two or four consecutive resource blocks associated with a precoding resource block group, wherein a demodulation reference signal sequence of the at least one co-scheduled user equipment is the same as a demodulation reference signal sequence of the user equipment, and wherein the at least one co-scheduled user equipment is in a first code division multiplexing group, and the user equipment is in a second code division multiplexing group different from the first code division multiplexing group.

Example 30. The apparatus of any of examples 18 to 29, wherein the at least one parameter is associated with: at least one demodulation reference signal power boosting configuration of a respective at least one co-scheduled user equipment being the same as a demodulation reference signal power boosting configuration of the user equipment, wherein a demodulation reference signal sequence of the at least one co-scheduled user equipment is the same as a demodulation reference signal sequence of the user equipment.

Example 31. The apparatus of any of examples 18 to 30, wherein the at least one parameter is associated with: at least one time domain resource assignment for physical downlink shared channel symbols of a respective at least one co-scheduled user equipment being the same as a time domain resource assignment for physical downlink shared channel symbols of the user equipment, wherein a demodulation reference signal sequence of the at least one co-scheduled user equipment is the same as a demodulation reference signal sequence of the user equipment.

Example 32. The apparatus of any of examples 18 to 31, wherein the at least one default setting for the at least one parameter for the multi-user multiple input multiple output advanced receiver is known to the user equipment following transmission of the configuration for multi-user multiple input multiple output.

Example 33. The apparatus of any of examples 18 to 32, wherein transmission of the configuration for multi-user multiple input multiple output causes the user equipment to apply the at least one default setting for the at least one parameter for the multi-user multiple input multiple output advanced receiver, without transmission or use of radio resource control based network assistant signaling for configuration of the multi-user multiple input multiple output advanced receiver.

Example 34. The apparatus of any of examples 18 to 33, wherein the apparatus comprises a radio access network node.

Example 35. A method including: receiving, from a network, a configuration for multi-user multiple input multiple output; and applying at least one default setting for at least one parameter for a multi-user multiple input multiple output advanced receiver, based on the configuration for multi-user multiple input multiple output.

Example 36. A method including: determining a configuration for multi-user multiple input multiple output; and transmitting, to a user equipment, the configuration for multi-user multiple input multiple output; wherein the configuration for multi-user multiple input multiple output causes the user equipment to apply at least one default setting for at least one parameter for a multi-user multiple input multiple output advanced receiver.

Example 37. An apparatus including: means for receiving, from a network, a configuration for multi-user multiple input multiple output; and means for applying at least one default setting for at least one parameter for a multi-user multiple input multiple output advanced receiver, based on the configuration for multi-user multiple input multiple output.

Example 38. An apparatus including: means for determining a configuration for multi-user multiple input multiple output; and means for transmitting, to a user equipment, the configuration for multi-user multiple input multiple output; wherein the configuration for multi-user multiple input multiple output causes the user equipment to apply at least one default setting for at least one parameter for a multi-user multiple input multiple output advanced receiver.

Example 39. A non-transitory computer readable medium including program instructions stored thereon for performing at least the following: receiving, from a network, a configuration for multi-user multiple input multiple output; and applying at least one default setting for at least one parameter for a multi-user multiple input multiple output advanced receiver, based on the configuration for multi-user multiple input multiple output.

Example 40. A non-transitory computer readable medium including program instructions stored thereon for performing at least the following: determining a configuration for multi-user multiple input multiple output; and transmitting, to a user equipment, the configuration for multi-user multiple input multiple output; wherein the configuration for multi-user multiple input multiple output causes the user equipment to apply at least one default setting for at least one parameter for a multi-user multiple input multiple output advanced receiver.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):
3GPP third generation partnership project
4G fourth generation
5G fifth generation
5GC 5G core network
6G sixth generation
AMF access and mobility management function
ASIC application-specific integrated circuit
CD compact/computer disc
CDM code division multiplexing
CPU central processing unit
CRS cell-specific reference signal
CU central unit or centralized unit
DCI downlink control information
DL downlink
DMRS, DM-RS demodulation reference signal
DSP digital signal processor
DU distributed unit
DVD digital versatile disc
eNB evolved Node B (e.g., an LTE base station)
E-UTRAN new radio-dual connectivity
en-gNB node providing NR user plane and control plane protocol terminations towards the UE, and acting as a secondary node in EN-DC
E-UTRA evolved UMTS terrestrial radio access, i.e., the LTE radio access technology
E-UTRAN E-UTRA network
F1 interface between the CU and the DU
FPGA field-programmable gate array
gNB base station for 5G/NR, i.e., a node providing NR user plane and control plane protocol terminations towards the UE, and connected via the NG interface to the 5GC
IAB integrated access and backhaul
I/F interface
I/O input/output
LMF location management function
LTE long term evolution (4G)
MAC medium access control
MCS modulation and coding scheme
MME mobility management entity
MRO mobility robustness optimization
MU-MIMO multi-user multiple input multiple output
NCE network control element
Neigh neighbor
ng or NG new generation
ng-eNB new generation eNB
NG-RAN new generation radio access network
NR new radio
N/W network
OAM operations, administration and maintenance
PDA personal digital assistant
PDCP packet data convergence protocol
PDSCH physical downlink shared channel
PHY physical layer
PRG precoding resource block group
QAM quadrature amplitude modulation
R4 RAN document (e.g. R4-2309895)
RAM random access memory
RAN radio access network
RAN1 RAN working group 1, or radio layer 1
RAN2 RAN working group 2
RAN4 RAN working group 4
Rel release
RLC radio link control
ROM read-only memory
RP RAN plenary
RRC radio resource control
RU radio unit
Rx receive, or receiver, or reception
SDAP service data adaptation protocol
SGW serving gateway
SMF session management function
SON self-organizing/optimizing network
TRP transmission and reception point
TS technical specification
Tx transmit, or transmitter, or transmission
UAV unmanned aerial vehicle
UE user equipment (e.g., a wireless, typically mobile device)
UI user interface
UMTS Universal Mobile Telecommunications System
UPF user plane function
USB universal serial bus
WI work item
X2 network interface between RAN nodes and between RAN and the core network
Xn network interface between NG-RAN nodes

1.-20. (canceled)

21. An apparatus comprising:
at least one processor; and
at least one memory storing instructions that, when executed by the at least one processor, cause the apparatus at least to:
receive, from a network, a configuration for multi-user multiple input multiple output; and
apply at least one default setting for at least one parameter for a multi-user multiple input multiple output advanced receiver, based on the configuration for multi-user multiple input multiple output.

22. The apparatus of claim 21, wherein the instructions, when executed by the at least one processor, cause the apparatus at least to:
receive, from the network, a configuration for the at least one parameter for the multi-user multiple input multiple output advanced receiver.

23. The apparatus of claim 22, wherein the instructions, when executed by the at least one processor, cause the apparatus at least to:
receive, from the network, an empty information element associated with the configuration for the at least one parameter for the multi-user multiple input multiple output advanced receiver;
apply the at least one default setting for the at least one parameter for the multi-user multiple input multiple output advanced receiver, in response to receiving the empty information element associated with the configuration for the at least one parameter for the multi-user multiple input multiple output advanced receiver.

24. The apparatus of claim 22, wherein the instructions, when executed by the at least one processor, cause the apparatus at least to:
determine to apply at least one non-default setting for one or more of the at least one parameter for the multi-user multiple input multiple output advanced receiver, in response to the one or more of the at least one parameter being present within the configuration for the at least one parameter for the multi-user multiple input multiple output advanced receiver.

25. The apparatus of claim 22, wherein the instructions, when executed by the at least one processor, cause the apparatus at least to:
determine to apply the at least one default setting for one or more of the at least one parameter for the multi-user multiple input multiple output advanced receiver, in response to the one or more of the at least one parameter being omitted from the configuration for the at least one parameter for the multi-user multiple input multiple output advanced receiver.

26. The apparatus of claim 22, wherein the configuration for the at least one parameter for the multi-user multiple input multiple output advanced receiver is received from the network via radio resource control signaling.

27. The apparatus of claim 22, wherein the instructions, when executed by the at least one processor, cause the apparatus at least to:
receive, from the network, signaling of the configuration for the at least one parameter for the multi-user multiple input multiple output advanced receiver;
wherein the signaling of the configuration for the at least one parameter for the multi-user multiple input multiple output advanced receiver comprises a modulation and coding scheme table having a highest modulation order higher among at least one modulation order of a respective at least one modulation and coding scheme table configured to a respective at least one co-scheduled user equipment, wherein a demodulation reference signal sequence of the at least one co-scheduled user equipment is the same as a demodulation reference signal sequence of the apparatus;
wherein the at least one modulation and coding scheme table comprises one of: a 1024quadrature amplitude modulation modulation and coding scheme table, or a 256 quadrature amplitude modulation modulation and coding scheme table, or a 64 quadrature amplitude modulation modulation and coding scheme table; and
apply a non-default setting for the at least one parameter for the multi-user multiple input multiple output advanced receiver, wherein the non-default setting is based on the modulation and coding scheme table having the highest modulation order higher among the at least one modulation order of the respective at least one modulation and coding scheme table configured to the respective at least one co-scheduled user equipment.

28. The apparatus of claim 22, wherein the instructions, when executed by the at least one processor, cause the apparatus at least to:
apply, for the at least one parameter, a default assumption that any of three modulation and coding scheme tables have a highest modulation order among at least one modulation order of a respective at least one modulation and coding scheme table configured to a respective at least one co-scheduled user equipment, in response to determining that signaling of the configuration for the at least one parameter for the multi-user multiple input multiple output advanced receiver is received without a modulation and coding scheme table having the highest modulation order among the at least one modulation order of the respective at least one modulation and coding scheme table configured to the respective at least one co-scheduled user equipment;
wherein the three modulation and coding scheme tables comprise a 1024 quadrature amplitude modulation modulation and coding scheme table, a 256 quadrature amplitude modulation modulation and coding scheme table, and a 64 quadrature amplitude modulation modulation and coding scheme table.

29. The apparatus of claim 22, wherein the configuration for the at least one parameter for the multi-user multiple input multiple output advanced receiver is received from the network via explicit radio resource control based network assistant signaling.

30. The apparatus of claim 21, wherein the at least one parameter is associated with a valid state or a valid assumption.

31. The apparatus of claim 21, wherein the at least one parameter is associated with an invalid state or an invalid assumption.

32. The apparatus of claim 21, wherein the at least one parameter is associated with: a precoding and resource allocation of at least one co-scheduled user equipment being the same as a precoding and resource allocation of the apparatus, in a precoding resource block group level grid configured to the apparatus when there are two or four consecutive resource blocks associated with a precoding resource block group, wherein a demodulation reference signal sequence of the at least one co-scheduled user equipment is the same as a demodulation reference signal sequence of the apparatus, and wherein the at least one co-scheduled user equipment is in a first code division multiplexing group, and the apparatus is in a second code division multiplexing group different from the first code division multiplexing group.

33. The apparatus of claim 21, wherein the at least one parameter is associated with: at least one demodulation reference signal power boosting configuration of a respective at least one co-scheduled user equipment being the same as a demodulation reference signal power boosting configuration of the apparatus, wherein a demodulation reference signal sequence of the at least one co-scheduled user equipment is the same as a demodulation reference signal sequence of the apparatus.

34. The apparatus of claim 21, wherein the at least one parameter is associated with: at least one time domain resource assignment for physical downlink shared channel symbols of a respective at least one co-scheduled user equipment being the same as a time domain resource assignment for physical downlink shared channel symbols of the apparatus, wherein a demodulation reference signal sequence of the at least one co-scheduled user equipment is the same as a demodulation reference signal sequence of the apparatus.

35. The apparatus of claim 21, wherein the at least one default setting for the at least one parameter for the multi-user multiple input multiple output advanced receiver is known to the apparatus following receipt of the configuration for multi-user multiple input multiple output.

36. The apparatus of claim 21, wherein the at least one default setting for the at least one parameter for the multi-user multiple input multiple output advanced receiver is applied in response to receipt of the configuration for multi-user multiple input multiple output, without receipt or use of radio resource control based network assistant signaling for configuration of the multi-user multiple input multiple output advanced receiver.

37. An apparatus comprising:
at least one processor; and
at least one memory storing instructions that, when executed by the at least one processor, cause the apparatus at least to:
determine a configuration for multi-user multiple input multiple output; and
transmit, to a user equipment, the configuration for multi-user multiple input multiple output;
wherein the configuration for multi-user multiple input multiple output causes the user equipment to apply at least one default setting for at least one parameter for a multi-user multiple input multiple output advanced receiver.

38. The apparatus of claim 37, wherein the instructions, when executed by the at least one processor, cause the apparatus at least to:
transmit, to the user equipment, a configuration for the at least one parameter for the multi-user multiple input multiple output advanced receiver.

39. The apparatus of claim 38, wherein the instructions, when executed by the at least one processor, cause the apparatus at least to:
transmit, to the user equipment, an empty information element associated with the configuration for the at least one parameter for the multi-user multiple input multiple output advanced receiver; and
wherein the empty information element associated with the configuration for the at least one parameter for the multi-user multiple input multiple output advanced receiver is configured to cause the user equipment to apply the at least one default setting for the at least one parameter for the multi-user multiple input multiple output advanced receiver.

40. A method comprising:
receiving, from a network, a configuration for multi-user multiple input multiple output; and
applying at least one default setting for at least one parameter for a multi-user multiple input multiple output advanced receiver, based on the configuration for multi-user multiple input multiple output.
